(19) United States
(12) Patent Application Publication
(10) Pub. No.: US 2026/0042330 A1
(43) Pub. Date: Feb. 12, 2026

(54) VIBRATION DAMPER UNIT FOR MACPHERSON CHASSIS

(71) Applicant: Vibracoustic SE, Weinheim (DE)

(72) Inventors: Ersan Altinoluk, Hamburg (DE); Dieter Bulling, Wedemark (DE)

(21) Appl. No.: 19/295,811

(22) Filed: Aug. 11, 2025

(30) Foreign Application Priority Data
Aug. 12, 2024 (DE) 10 2024 122 929.2

(51) Int. Cl. B60G 17/027; B60G 15/06

(52) U.S. Cl. CPC B60G 17/0272; B60G 15/062; B60G 15/067; B60G 2202/312; B60G 2202/41; B60G 2204/124; B60G 2204/128; B60G 2204/62; B60G 2500/20; B60G 2800/162; B60G 2800/916

(57) ABSTRACT

A vibration damper unit having a longitudinal axis includes a damper, a counter bearing that forms a first spring bearing face, a spring that bears against the first spring bearing face, and a base-adjusting device. The base-adjusting device may be offset from the counter bearing along the longitudinal axis and may have a first adjusting partner and a second adjusting partner that is arranged along the longitudinal axis at least partially between the first adjusting partner and the spring and is mounted movably relative to the first adjusting partner in an adjustment direction parallel to the longitudinal axis, has a force-absorbing element for absorbing an adjustment force and forms a second spring bearing face against which the spring bears. In embodiments, the second adjusting partner may comprise a bridging element between the second spring bearing face and the force-absorbing element.

### CROSS-REFERENCE TO RELATED APPLICATION

This application claims priority to German Patent Application No. DE 10 2024 122 929.2, filed on Aug. 12, 2024, the contents of which is hereby incorporated by reference in its entirety.

### TECHNICAL FIELD

The invention relates to, inter alia, a vibration damper unit.

### BACKGROUND

A longitudinal axis may extend through a vibration damper unit. A vibration damper unit may comprise a damper, a counter bearing, and a spring. The counter bearing may form a first spring bearing face against which the spring bears. Furthermore, a vibration damper unit may comprise a base-adjusting device, which is offset from the counter bearing along the longitudinal axis. The base-adjusting device may have a first adjusting partner and a second adjusting partner. The second adjusting partner may be arranged along the longitudinal axis at least partially between the first adjusting partner and the spring. The second adjusting partner may be mounted movably relative to the first adjusting partner in an adjustment direction parallel to the longitudinal axis. The second adjusting partner may have a force-absorbing element for absorbing an adjustment force and may form a second spring bearing face against which the spring bears.

Such a vibration damper unit may form a chassis. In some known vibration damper units, the force-absorbing element may form the second spring bearing face.

DE 10 2014 108 241 B4 illustrates different types of chassis with vibration damper units, which are not of the type in question but comprise a hydraulic actuator for height adjustment. A first illustrated chassis type (FIGS. 2 and 3) characteristically has, in addition to a vibration damper unit, both a lower control arm and an upper control arm between a wheel carrier, on which a wheel is mounted, and a vehicle body. Vertical control of the wheel carrier is defined entirely by the two control arms. The vibration damper unit therefore only has to assume the functions of suspension and damping. This allows relatively free positioning both of the vibration damper unit, for example between the vehicle body and the lower control arm, and of the actuator, for example at the lower base of the damper. The actuator in the first chassis type does not form a spring bearing face, in contrast to the vibration damper unit of the type in question. A second chassis type illustrated by DE 10 2014 108 241 B4 (FIG. 4) does not have an upper control arm. Instead, the vibration damper unit in this case also assumes the function of controlling the upper control arm of the first chassis type, in addition to its aforementioned functions. For this purpose, an end of the damper of the vibration damper unit remote from the counter bearing is arranged directly on the wheel carrier.

The second chassis type is referred to as a MacPherson chassis. In this embodiment, there is no installation space for an actuator between a tire of the wheel and the damper, since the damper, as a part of the chassis, should or must be arranged close to the wheel for kinematic reasons. For this reason, the actuator according to the prior art is placed on the portion of the damper positioned above the tire.

The actuator competes with the spring for installation space above the wheel. Assuming a fixed vertical distance of the counter bearing from the wheel, the competition for installation space means that the spring should or must be made shorter than it would be in the absence of the actuator to achieve the best possible driving properties of the vehicle to be equipped with the vibration damper unit. This is also the case in the known vibration damper unit of the type in question. The shortening of the spring associated with the actuator results in disadvantageous driving comfort properties.

### SUMMARY

An object of the invention may be to provide a vibration damper unit of the type in question by means of which the disadvantages described above can be avoided. Another object of the invention can be to provide a chassis device that is constructed in a most simple and space-saving manner and by means of which one or more disadvantages, such as described above can be avoided.

A first object may be achieved by the vibration damper unit described below. According to aspects or teachings of the invention, a second adjusting partner may comprise a bridging element between the second spring bearing face and the force-absorbing element. The bridging element has an outer surface, which faces away from the longitudinal axis and has, at least in some regions, a first distance from the longitudinal axis, said first distance being smaller than a second distance at least of a region of an outer surface, facing away from the longitudinal axis, of the force-absorbing element and/or of the first adjusting partner from the longitudinal axis.

The first distance and the second distance are in particular to be measured in the same radial direction in relation to the longitudinal axis. The bridging element allows the creation of a slim portion of the vibration damper unit between the spring and the first adjusting partner, said portion adding only a little bulk to the damper such that the bridging element can be arranged directly next to the wheel without causing installation space problems. This distinguishes the bridging element in particular from the spring and the force-absorbing element and/or the first adjusting partner.

In the installation situation described, the bridging element allows the effect of the base-adjusting device to be transferred along the wheel. By means of the bridging element, the base-adjusting device can be at least partially spaced further from the counter bearing than previously. Preferably, the force-absorbing element can be spaced from the spring. In particular, a distance of the base-adjusting device from a rotational axis of the wheel is reduced to such an extent that the base-adjusting device is closer to the rotational axis than a rim ring of the wheel. In particular, a construction can be achieved in which a part of the wheel closest to the damper, in particular the rim flange, is arranged between the force-absorbing element and the second bearing face in the axial direction. As a result, the competition for installation space between the base-adjusting device and the spring can be resolved, and space can be created for the spring to be lengthened. Optimal spring properties can thus be achieved in terms of the spring length without having to omit the base-adjusting device.

The counter bearing of the vibration damper unit is provided for fixed mounting on a vehicle structure, in particular body, of the vehicle. The vibration damper unit is preferably designed such that the wheel carrier is decoupled rotatably relative to the vehicle structure. In particular, the first spring bearing face can be designed such that it decouples the spring rotatably from the vehicle structure when the vibration damper unit is in use. In addition, the counter bearing can also contain elastic decoupling elements and/or further components, which are not discussed in detail here, since they are not essential to the invention. Additionally or alternatively, it is possible for the spring to be mounted rotatably on the second spring bearing face, and/or for the first adjusting partner to be mounted rotatably relative to the wheel carrier, and/or for a torsional decoupling system to be provided inside the base-adjusting device. The spring bears with its upper end against the first spring bearing face and with its lower end against the second spring bearing face. The spring is in particular designed as a spiral spring and surrounds the damper between said spring bearing faces.

The vibration damper unit is in particular designed as a suspension strut. Preferably, the vibration damper unit is designed as a MacPherson strut, which is characteristically designed, beyond the pure suspension and damper effect, to absorb forces transmitted to the vibration damper unit by the wheel during operation. In this case, the spring extends in particular spirally around a spring longitudinal axis that is oriented at an angle to the above-described longitudinal axis of the vibration damper unit and in particular of the damper. Thanks to the angling of the spring longitudinal axis to the longitudinal axis, the spring is optimally designed to absorb said forces.

In particular, the damper comprises a damper rod and a damper tube, which are movable relative to one another, preferably in the adjustment direction. The damper rod is preferably arranged on the counter bearing. The damper tube is preferably to be arranged on the wheel carrier during use. In particular, the damper comprises a cover, which is placed on an end of the damper tube nearest the counter bearing. Preferably, at least a part of the damper rod is surrounded by an additional spring, which in particular bears against the counter bearing.

The base-adjusting device is in particular an actuator. The first adjusting partner is preferably a first actuator half, and the second adjusting partner is preferably a second actuator half.

The adjusting partners are of single- or multi-piece and rigid design. Preferably, the adjusting partners surround the longitudinal axis completely. Particularly preferably, the adjusting partners are at least substantially axially symmetrical. The first adjusting partner is in particular arranged fixedly on the damper tube and provided to bear against the wheel carrier. The second adjusting partner is preferably mounted directly on the first adjusting partner. The second adjusting partner is displaceable in the adjustment direction relative to the first adjusting partner from a close position to a remote position and back.

The base-adjusting device is preferably to be operated hydraulically. As an alternative to the design of the base-adjusting device for hydraulic operation, the base-adjusting device can be designed for pneumatic operation, for example. In particular for one of these cases, the base-adjusting device preferably forms a fluid chamber of variable size. The fluid chamber is particularly preferably arranged between the first adjusting partner and the second adjusting partner, particularly preferably clamped onto the adjusting partners. To move the second adjusting partner relative to the first adjusting partner, a fluid can be conveyed into the fluid chamber or out of the fluid chamber. The fluid is preferably a gas or an incompressible liquid, in particular hydraulic oil. To form the fluid chamber, the base-adjusting device preferably has at least one bag. The bag preferably extends from the first adjusting partner to the second adjusting partner. The bag is in particular formed from an elastomer and/or surrounds the longitudinal axis, in particular completely. Preferably, the bag is adjacent to an outer surface, facing away from the longitudinal axis, of the first adjusting partner and/or to an outer surface, facing away from the longitudinal axis, of the second adjusting partner. In particular, the bag forms at least one roll fold, in order to be able to unroll for enlargement of the fluid chamber and to roll up for reduction of the fluid chamber. If a base-adjusting device as described above is used, which has characteristic advantages and a considerable space requirement in comparison with differing base-adjusting devices, the above-described advantages have a particularly extensive effect.

The force-absorbing element of the second adjusting partner in particular forms an end of the second adjusting partner nearest the first adjusting partner. Preferably, the force-absorbing element is directly adjacent to the first adjusting partner and/or to the fluid chamber and is designed to absorb the force acting from outside on the second adjusting partner for its movement relative to the first adjusting partner. The force-absorbing element preferably protrudes radially from the longitudinal axis, in particular in relation to the bridging element. Particularly preferably, the force-absorbing element extends around the damper in a collar- or flange-like manner.

A first auxiliary surface, which surrounds the longitudinal axis at a uniform distance and within which the bridging element is arranged, preferably intersects the force-absorbing element and/or the first adjusting partner. The first auxiliary surface is in particular an endless cylindrical face. The first auxiliary surface does not intersect the bridging element but optionally touches it. The radius of the auxiliary surface in particular corresponds to said first distance. The force-absorbing element and/or the first adjusting partner is particularly preferably intersected by the first auxiliary surface along an interface completely surrounding the longitudinal axis. By means of this preferred embodiment, a fully circumferentially slim shape of the bridging element is achieved, which thus preferably has a smaller diameter than the force-absorbing element.

A length of the bridging element measured in the adjustment direction is preferably greater than the second distance, particularly preferably greater than twice the second distance, in particular greater than three times the second distance. The second distance is the distance at least of said region of the outer surface of the force-absorbing element and/or of the first adjusting partner from the longitudinal axis. The length is preferably greater than half the length of the second adjusting element or even of the entire base-adjusting device, at least in one of said positions. The length of the bridging element is in particular understood as a distance between the force-absorbing element and the second spring bearing face or a component forming the second spring bearing face. If a base-adjusting device of typical extent is used, in particular with a fluid chamber of typical extent, it is ensured by the length of the bridging element that it extends along the entire tire and allows freedom of movement in the adjustment direction. The second spring bearing face is in particular formed by the second adjusting partner such that it is arranged movably relative to the damper, in particular to the damper component surrounded by the second spring bearing face, preferably to the damper tube. The first adjusting partner is preferably arranged fixedly relative to the damper or to the damper component.

The bridging element is preferably tubular. This means that the bridging element is designed as an elongate hollow body. As a result, the bridging element is provided with a structural stability that, even with a long length, still allows a consistently small first distance of the outer surface of the bridging element from the longitudinal axis. In the sense of stability, the bridging element is preferably formed integrally with the force-absorbing element or welded thereto. However, it can also be connected to the force-absorbing element in a form- and/or force-fitting manner, for example screw-fastened or adhesively bonded thereto.

Preferably, the bridging element is designed such that the first distance corresponds to at most 70%, preferably at most 50% of the second distance. As a result, a fluid chamber of sufficient size is made possible on the one hand, and sufficient space is created even for wider tires next to the bridging element on the other hand.

The second adjusting partner preferably has a spring bearing element that forms the second spring bearing face. In this case, the spring bearing element is arranged between the bridging element and the spring and protrudes radially from the bridging element, in particular in a similar manner to the force-absorbing element. In particular, the spring bearing element is collar-shaped and/or annular. Particularly preferably, the spring bearing element is a spring seat. Preferably, the spring bearing element is, like the force-absorbing element, intersected by the first auxiliary surface and welded to the bridging element. By means of the spring bearing element, a second spring bearing face of conventional extent is still made possible even with a particularly slim bridging element.

At least two axial guide rings, which are offset from one another in the adjustment direction, are arranged between the second adjusting partner and the damper. In particular, these are preferably slide elements or slide bushes formed from a plastic. Particularly preferably, a first axial guide ring is arranged in the region of the force-absorbing element, and a second axial guide ring is arranged in the region of the spring bearing element. Thanks to the use of a plurality of axial guide rings, the second adjusting partner is prevented from tilting, and thus its reliable displaceability is ensured even with a particularly long length of the second adjusting partner, without direct frictional contact and thus wear and/or noise occurring between the damper and the adjusting partner.

Particularly preferably, at least one of the axial guide rings is arranged between the first adjusting partner and the second adjusting partner. In this case, the second adjusting partner is mounted directly on the first adjusting partner. This is in particular the axial guide ring furthest away from the spring. In an alternative embodiment of the invention, this axial guide ring is arranged directly between the second adjusting partner and the damper and in particular offset from the first adjusting element.

A second object may be achieved by the chassis device such as described below. The chassis device has a wheel carrier, a wheel hub, which is mounted on the wheel carrier rotatably about a rotational axis, and a wheel arranged on the wheel hub. The wheel comprises a wheel rim with the rim ring extending rotationally symmetrically around the rotational axis. The chassis device also comprises a vibration damper unit of the type in question. The vibration damper unit of the chassis device according to the invention is preferably, but not necessarily, designed in accordance with the vibration damper unit described above as according to the invention. Alternatively, it is at least a vibration damper unit of the type in question. An end of the damper remote from the counter bearing is arranged on the wheel carrier.

In the chassis device according to the invention, the base-adjusting device of the vibration damper unit is arranged at least partially inside a rim interior. The rim interior extends within the rim ring and adjacently to a rim side plane. The rim side plane extends at right angles to the rotational axis and laterally touches the rim ring.

By means of the chassis device according to the invention, the base-adjusting device is given a space that was not previously used for this. This allows a modified construction of the base-adjusting device. Preferably, the adjusting partners and in particular the fluid chamber are to be designed in an elongate manner in relation to the longitudinal axis from the spring into the rim interior while maintaining the volume of the fluid chamber. In particular, the base-adjusting device is to be designed with the bridging element, with which the second adjusting partner preferably extends along the rim ring. As a result, the described competition for installation space between the base-adjusting device and the spring can at least partially be resolved. The spring can be lengthened. As a result, better spring properties can be realized without having to forgo the advantages of the base-adjusting device.

The chassis device is used in particular to form a MacPherson chassis. For this purpose, the damper, in particular its damper tube, is connected, preferably fixedly, to the wheel carrier. The wheel carrier is in particular designed such that the rim side plane intersects it.

When the vibration damper unit according to the invention is used in the chassis device according to the invention, the bridging element preferably extends closer to the rotational axis than the rim ring is spaced from the rotational axis. As a result, the security against a collision of the force-absorbing element with the rim ring is increased. The rim side plane in particular intersects the first adjusting partner; it preferably intersects both the first adjusting partner and the second adjusting partner. This applies at least in the maximally retracted position, i.e., in the position in which the force-absorbing element has approached the wheel carrier most closely in the direction of the longitudinal axis.

Preferably, the base-adjusting device is arranged partially inside the rim interior such that an auxiliary line parallel to the longitudinal axis and touching the force-absorbing element and/or the first adjusting partner intersects the rim ring. The statement made above applies in relation to a longitudinal section along a longitudinal plane in which the longitudinal axis lies. As a result, a particularly compact construction is achieved, in which in particular a rim flange of the wheel can have a smaller distance from the longitudinal axis than the outer surface of the force-absorbing element and/or of the first adjusting partner.

Preferably, the spring bearing element is arranged above the wheel such that the spring bearing element is arranged at least partially outside a second auxiliary surface that surrounds the rotational axis at a uniform distance. In this case, the entire wheel is arranged within the second auxiliary surface.

The longitudinal axis and the rotational axis are imaginary, geometric axes. Said auxiliary surfaces and the rim side plane are imaginary, geometric faces. The rim space is an imaginary, geometric space, the limits of which do not have to be physical.

### BRIEF DESCRIPTION OF THE DRAWINGS

Further details and advantages of the invention can be found in the schematically shown figures described below; in the figures:

FIG. 1 shows a first chassis device according to aspects or teachings of the disclosure and in a sectional diagram; and

FIG. 2 shows a second chassis device according to aspects or teachings of the disclosure and in a sectional diagram.

### DETAILED DESCRIPTION

In the figures, the same or corresponding elements are each denoted by the same reference signs and are therefore not described repeatedly, unless expedient. The disclosures in the description as a whole can be transferred, mutatis mutandis, to the same parts with the same reference signs or the same component names. The position information selected in the description also relates to the described figure. The features described below can also form the subject matter of the invention in a combination other than that directly described or shown.

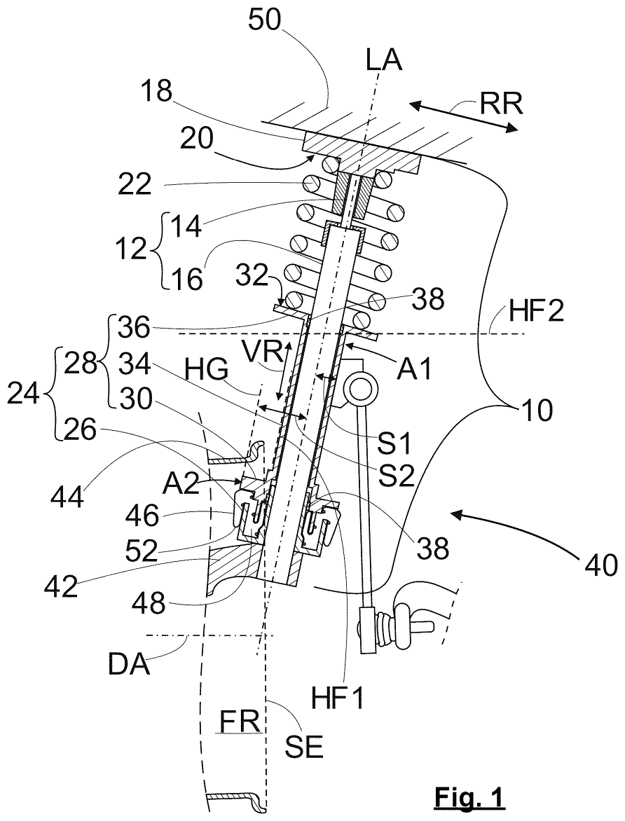

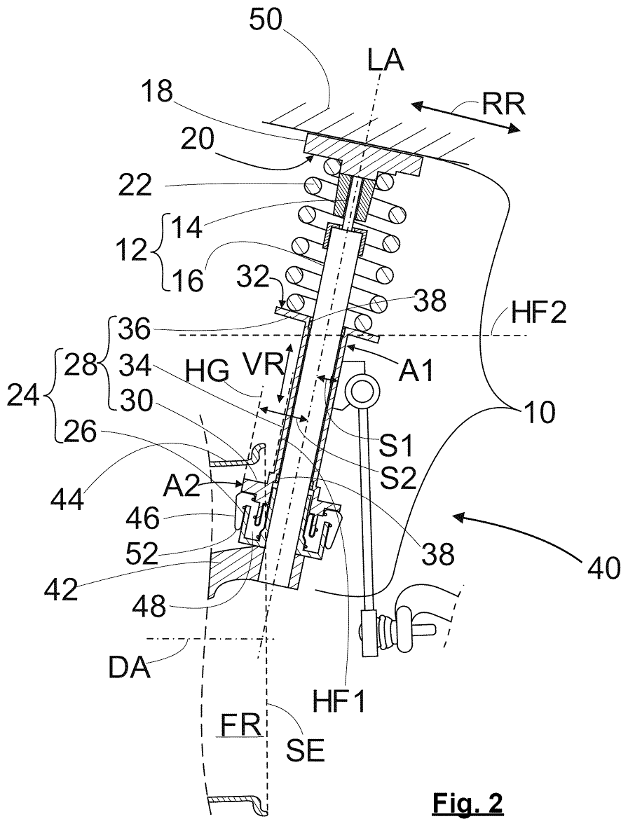

FIGS. 1 and 2 show two chassis devices 40 according to the invention, which are the same as one another with the exception of the arrangement of axial guide rings 38. First, the features illustrated both in FIG. 1 and in FIG. 2 are described below.

In each case, a central component of the chassis devices 40 is a vibration damper unit 10. A longitudinal axis LA extends through the vibration damper unit 10. The vibration damper unit 10 comprises a counter bearing 18, which is arranged on a vehicle structure 50, and a damper 12. The damper 12 comprises a damper rod 14, which is arranged on the counter bearing 18, and a damper tube 16, which is arranged on a wheel carrier 42 of the chassis device 40.

The vibration damper unit 10 comprises a spring 22, which extends spirally around a part of the damper 12. A base-adjusting device 24 is arranged between the wheel carrier 42 and the spring 22. The base-adjusting device 24 comprises a first adjusting partner 26, which is arranged fixedly relative to the damper tube 16 and bears against the wheel carrier 42, and a second adjusting partner 28. The second adjusting partner 28 is arranged between the first adjusting partner 26 and the spring 22 and is mounted movably relative to the first adjusting partner 26 in an adjustment direction VR parallel to the longitudinal axis LA. The first adjusting partner 26 and the second adjusting partner 28 are connected to one another by means of a bag 46. The bag 46 has a roll fold 52 adjacent to the first adjusting partner 26. The adjusting partners 26, 28 and the bag 46 form a fluid chamber 48. An end of the second adjusting partner 28 nearest the first adjusting partner 26 is formed by a force-absorbing element 30. An end of the second adjusting partner 28 nearest the spring 22 is formed by a spring bearing element 36.

The second adjusting partner 28 has a tubular bridging element 34 between the spring bearing element 36 and the force-absorbing element 30. The bridging element 34 has an outer surface A1, which faces away from the longitudinal axis LA and has a first distance S1 from the longitudinal axis LA. The first distance S1 is smaller than a second distance S2 of an outer surface A2, facing away from the longitudinal axis LA, of the force-absorbing element 30 from the longitudinal axis LA. The distances S1, S2 are each measured in a radial direction RR.

In detail, the bridging element 34 is designed such that its outer surface A1 lies in a first auxiliary surface HF1. The first auxiliary surface HF1 surrounds the longitudinal axis LA at the uniform distance S1. The first auxiliary surface HF1 fully circumferentially intersects the force-absorbing element 30. A length Li, measured in the adjustment direction VR, of the bridging element 34 is greater than three times the second distance S2.

The spring 22 bears against a first spring bearing face 20 of the counter bearing 18 on one side. On the other side, the spring 22 bears against a second spring bearing face 32 of the spring bearing element 36. A preloading of the spring 22 can therefore be varied by moving the second adjusting partner 28 in the adjustment direction VR.

Beyond the vibration damper unit 10, the chassis device 40 has the wheel carrier 42, a wheel hub (not shown), which is mounted on the wheel carrier 42 rotatably about a rotational axis DA, and a wheel arranged on the wheel hub. The wheel comprises a rim ring 44, which extends rotationally symmetrically around the rotational axis DA and is the only component of the wheel shown in the figures.

The base-adjusting device 24 is arranged partially inside a rim interior FR. The rim interior FR extends inside the rim ring 44 and is adjacent to a rim side plane SE, which is oriented at right angles to the rotational axis DA and touches the rim ring 44.

A second auxiliary surface HF2 has a uniform distance from the rotational axis DA, said distance corresponding to a distance of an outer surface of a tire (not shown) of the wheel. The base-adjusting device 24 is arranged such that the spring bearing element 36 is arranged at least partially outside an interior of the second auxiliary surface HF2. Furthermore, the base-adjusting device 24 is arranged such that an auxiliary line HG, which is parallel to the longitudinal axis LA and touches the force-absorbing element 30, intersects the rim ring 44, in particular in the region of the rim flange.

According to both FIG. 1 and FIG. 2, the second adjusting partner 28 is mounted by means of two axial guide rings 38. In each case, an upper of the axial guide rings 38 is arranged in the region of the spring bearing element 36 between the second adjusting partner 28 and the damper tube 16. A second axial guide ring 38 is arranged between the second adjusting partner 28 and the first adjusting partner 26 according to FIG. 1 and between the second adjusting partner 28 and the damper tube 16 according to FIG. 2.

1. A vibration damper unit, comprising:
a longitudinal axis extending therethrough,
a damper,
a counter bearing, which forms a first spring bearing face,
a spring, which bears against the first spring bearing face, and
a base-adjusting device, which is offset from the counter bearing along the longitudinal axis and has a first adjusting partner and a second adjusting partner, which is arranged along the longitudinal axis at least partially between the first adjusting partner and the spring and is mounted movably relative to the first adjusting partner in an adjustment direction parallel to the longitudinal axis, has a force-absorbing element for absorbing an adjustment force and forms a second spring bearing face against which the spring bears,
wherein the second adjusting partner comprises a bridging element between the second spring bearing face and the force-absorbing element, the bridging element having an outer surface, which faces away from the longitudinal axis and has, at least in some regions, a first distance from the longitudinal axis, the first distance being smaller than a second distance at least of a region of an outer surface, facing away from the longitudinal axis, of the force-absorbing element and/or of the first adjusting partner from the longitudinal axis.

2. The vibration damper unit according to claim 1, wherein a first auxiliary surface, which surrounds the longitudinal axis at a uniform distance and within which the bridging element is arranged, intersects the force-absorbing element and/or the first adjusting partner.

3. The vibration damper unit according to claim 1, wherein a length of the bridging element measured in the adjustment direction is greater than the second distance.

4. The vibration damper unit according to claim 1, wherein a length of the bridging element measured in the adjustment direction is greater than twice the second distance.

5. The vibration damper unit according to claim 1, wherein a length of the bridging element measured in the adjustment direction is greater than three times the second distance.

6. The vibration damper unit according to claim 1, wherein the bridging element is tubular.

7. The vibration damper unit according to claim 1, wherein the bridging element is such that the first distance corresponds to at most 70% of the second distance.

8. The vibration damper unit according to claim 1, wherein the bridging element is such that the first distance corresponds to at most 50% of the second distance.

9. The vibration damper unit according to claim 1, wherein the second adjusting partner has, between the bridging element and the spring, a spring bearing element, which protrudes radially from the bridging element and has the second spring bearing face.

10. The vibration damper unit according to claim 1, wherein at least two axial guide rings, which are offset from one another in the adjustment direction, are arranged between the second adjusting partner and the damper.

11. The vibration damper unit according to claim 10, wherein at least one of the axial guide rings is arranged between the first adjusting partner and the second adjusting partner.

12. A chassis device, having:
a wheel carrier;
a wheel hub, which is mounted on the wheel carrier rotatably about a rotational axis;
a wheel, which is arranged on the wheel hub and has a wheel rim, which has a rim ring extending rotationally symmetrically around the rotational axis; and
a vibration damper unit, through which a longitudinal axis extends and which comprises a damper, a counter bearing, which forms a first spring bearing face, a spring, which bears against the first spring bearing face, a base-adjusting device, which is offset from the counter bearing along the longitudinal axis and has a first adjusting partner and a second adjusting partner, which is arranged along the longitudinal axis at least partially between the first adjusting partner and the spring and is mounted movably relative to the first adjusting partner in an adjustment direction parallel to the longitudinal axis, has a force-absorbing element for absorbing an adjustment force and forms a second spring bearing face against which the spring bears,
wherein an end of the damper remote from the counter bearing is arranged on the wheel carrier, and
wherein the base-adjusting device is arranged at least partially inside a rim interior, which extends within the rim ring and adjacently to a rim side plane, which is oriented at right angles to the rotational axis and touches the rim ring.

13. The chassis device according to claim 12, wherein the vibration damper unit is as defined in claim 1.

14. The chassis device according to claim 12, wherein a bridging element of the vibration damper unit extends closer to the rotational axis than the rim ring is spaced from the rotational axis.

15. The chassis device according to claim 12, wherein the base-adjusting device is partially arranged inside the rim interior such that, in a longitudinal section along a longitudinal plane in which the longitudinal axis lies, an auxiliary line parallel to the longitudinal axis and touching the force-absorbing element and/or the first adjusting partner intersects the rim ring.

16. The chassis device according to claim 12, wherein the base-adjusting device forms a fluid chamber of variable size between the first adjusting partner and the second adjusting partner.

17. The chassis device according to claim 16, wherein the base-adjusting device has at least one bag, which extends from the first adjusting partner to the second adjusting partner and forms at least one roll fold, to form the fluid chamber.
